(19) United States
(12) Patent Application Publication
(10) Pub. No.: US 2003/0152833 A1
(43) Pub. Date: Aug. 14, 2003

(54) Accumulator

(76) Inventors: Detlef Ohms, Brilon (DE); Michael Kohlhase, Brilon (DE); Katja Hogrebe, Brilon (DE); Gabor Benczur-Urmossy, Stuttgart (DE); Willi Kitzhofer, Brilon (DE); Birgit Bange, Brilon (DE)

Correspondence Address: CANTOR COLBURN, LLP, 55 GRIFFIN ROAD SOUTH, BLOOMFIELD, CT, 06002

(21) Appl. No.: 10/268,193

(22) Filed: Oct. 9, 2002

(30) Foreign Application Priority Data
Oct. 17, 2001 (DE) 101 51 099.3

(51) Int. Cl. H01M 10/18; H01M 2/02

(52) U.S. Cl. 429/210; 429/66

(57) ABSTRACT

To improve upon an accumulator (1) in a bipolar stack configuration comprising a number of sub-cells (9) arranged in layers within a housing (2) and separated by conductive partitions (8), wherein each sub-cell (9) has a positive (10) and a negative (11) electrode and a separator (12) between the electrodes (10, 11), as well as electrolytes in contact with the electrodes, such that the stack comprised of the sub-cells (9) can be fastened easily and safely via mechanical means, it is suggested that the stack, comprised of several sub-cells layered on top of one another be held in place via a force that will keep the individual elements (8, 10, 11, 12) of the stack in contact with one another with only a mechanical tie rod (14).

The patent concerns an accumulator in a bipolar stack configuration having a number of cells comprised of sub-cells arranged in layers in a housing and separated by conductive partitions, wherein each sub-cell is equipped with a positive and a negative electrode with a separator positioned between the electrodes, and electrolytes that are in contact with the electrodes.

Accumulators constructed in such a manner have recently received increased attention as an alternative to accumulators that are constructed using the block construction method. The latter accumulators are constructed using individually closed galvano cells. Each of these cells is equipped with two electrodes, a separator between them, and a number of operating electrolytes. The electrodes of the individual galvano cells can be connected via terminals. For the construction of the accumulator, several galvano cells are electrically connected to one another via suitable electrical connectors. Thus, the accumulator of the block method is comprised of individual, physically separate galvano elements or cells.

In contrast, the accumulator of the type mentioned initially is constructed using individual sub-cells that are connected directly to one another. Hence no electrical contact elements are required for connecting individual galvano elements. The advantageous result is that power losses, such as are ordinarily caused by connecting elements of this type, do not occur in accumulators of the type initially described.

In the construction of accumulators having a bipolar stack configuration, the above-mentioned electrodes, separators, and conductive partitions must be stacked in layers in such a way as to form a desired number of sub-cells. The elements layered in a stack must be connected to one another mechanically to prevent them from becoming separated. Since the accumulator releases gas during its operation, specifically gaseous hydrogen and gaseous oxygen, causing an increase in pressure, the connection must be resistant to pressure to prevent the separation of individual elements within a sub-cell. Otherwise, the result could be a disadvantageous interruption of electrical contact or a discharge of electrolytes from the sub-cells, which would negatively affect the operation of the accumulator.

Various connection technologies are suggested for the mechanical and pressure-proof connection of the individual elements forming the stack. The common denominator of all suggested technologies, such as the use of clamping elements, is the complication of the stack configuration or the necessity of a large number of connecting elements to effect a pressure-proof, safe mechanical connection of the sub-cell stack.

Based upon this state of the art, the objective of the present invention is to improve the accumulator of the type described initially in such a way that the stack formed from the individual sub-cells can be made pressure-proof via simple means, and that an accumulator constructed in this manner is simple and can be manufactured economically.

To achieve this objective, it is suggested by the invention that the stack of sub-cells layered on top of one another be fastened via a force that will hold the individual elements of the stack in contact with one another via only a mechanical tie rod.

The use of a mechanical tie rod for fastening the stack as suggested by the invention can be easily realized, and, with the proper construction, for example by positioning the tie rod centrally relative to the individual elements in the stack, the stack can be safely pressurized and fastened using only one element.

Furthermore, a tie rod of this type can be made available economically and can be handled very easily, enabling a comparatively simple construction for the accumulator according to the invention.

An especially advantageous design for the accumulator specified in the invention results if the stack, consisting of several sub-cells layered on top of one another, is fastened to a housing cover by a tie rod, in accordance with an advantageous further development of the invention. A simple modular construction for the accumulator can be realized with such a design. A first module comprises a housing without a cover. A second module is formed by the sub-cell stack, which is fastened to the housing cover via the tie rod, and by the housing cover itself. To construct the accumulator, the sub-cells are inserted into the housing, wherein the housing is sealed simultaneously with the cover. It is further suggested that preferably a pressure-proof connection be formed between the housing cover and the housing. In such a construction, the housing cover advantageously functions simultaneously as a pressure plate, which serves as a counterfort for the power exerted on the sub-cells via the tie rod. The mechanical fastening strength of the tie rod and the rigid housing act against the pressure exerted by the creation of gas during the operation of the accumulator.

In accordance with another further advantageous development of the invention, contact plates are provided at the end of the stack formed by each sub-cell, adjacent to the last element, via which the sub-cells are connected to the terminals to establish contact with the accumulator. Via the contact plates, which preferably are in large area contact with the adjacent elements of the sub-cells, the terminals connected to the contact plates are reliably brought up to the potential of the connected side of the first or last sub-cell of the appropriate contact plate. In addition to the contact plates, pressure plates can also be provided on the side of the contact plate opposite the sub-cell, via which pressure can be applied to the individual sub-cells or to the elements that form the sub-cells, to create a stable fastening of the stack. If, as described above, the tie rod is attached to the housing cover, the cover can function as a pressure plate.

According to another advantageous further development of the invention, the tie rod can be led outside of the housing, simultaneously forming a terminal of the accumulator. Of course, the opening passage for the tie rod must be sealed at the housing or the housing cover to prevent the release of electrolytes or gasses from the inside of the housing through this opening.

An especially favorable distribution of the pressure created by the tie rod is achieved if the tie rod is led through central openings in the elements forming the stack, as is suggested in accordance with another beneficial further development of the invention.

Finally, according to another advantageous further development of the invention, it is suggested that the housing be constructed in cylindrical form. A cylindrical housing, especially a circular cylindrical housing, proves to be particularly resistant to pressure, and is therefore especially well suited to withstand the pressures created in the accumulator during operation.

The accumulator specified in the invention is preferably a metal hydride accumulator, most preferably a nickel metal hydride accumulator.

Further characteristics and advantages of the invention are described below using a design example with the sole attached figure.

The diagram shows a cross-section illustrating the construction of the accumulator 1 specified in the invention, in a bipolar stack configuration. The entire structure of the accumulator 1 is contained within the housing 2, which is enclosed by the housing cover 3. The housing 2 and the housing cover 3 are connected to one another, in a pressure-resistant connection, for example via screws (not shown in the figure). Sub-cells 9 are layered on top of one another in a stack, and are separated spatially from one another via conductive partitions 8. The conductive partitions 8 prevent penetration of the electrolytes from one area of a sub-cell 9 into the area of another sub-cell 9, but create an electrical connection between adjacent sub-cells 9.

Each sub-cell 9 is equipped with a positive electrode 10, a negative electrode 11, and a separator 12 between the electrodes. The area between electrodes 10 and 11 is filled with an electrolyte (not shown). Between the negative electrode 11 of a sub-cell 9 and the positive electrode 10 of the adjacent sub-cell 9, a conductive partition 8 is installed. The positive electrode 10 and the negative electrode 11 of the two adjacent sub-cells 9 are connected to one another electrically. The conductive partition 8 may also be referred to as a bipolar partition based upon the adjacent electrodes of different polarities.

The stack formed from individual sub-cells 9 is delimited on the top and bottom by contact plates 4 and 5, as shown in the figure. The contact plates lie holohedrally on the adjacent sub-cell 9 and form a good electrical connection with the sub-cell 9. The contact plate 5 shown toward the bottom of the diagram connects with the side of a pressure plate 13 that is opposite the stack comprised of sub-cells 9. This pressure plate can be used to apply pressure to the stack of sub-cells 9 thus holding it together. On the opposite side, the housing cover 3 functions as a pressure plate.

Starting from the contact plate 5 shown in the figure, a tie rod 14 protrudes through all su~cells 9 at their center. The tie rod 14 is led through an opening in the housing cover 3 and is fastened via a nut 15 to the housing cover. The area where the tie rod 14 protrudes through the housing cover is sealed with an appropriate sealant in such a way that neither the electrolyte nor the gas created in the accumulator during the operation can be released. The tie rod 14 is connected electrically to the contact plate 5 and thereby serves as a positive terminal 7 for the accumulator. The negative terminal 6 of the accumulator is connected to the contact plate 4 shown in the figure and is led through the housing cover 3 and sealed. The pressure plate 13 and the cover 3 are pressed together by force of the nut 15 screwed onto the tie rod 14, and the sub-cells 9 positioned between them are held in place by the resulting force.

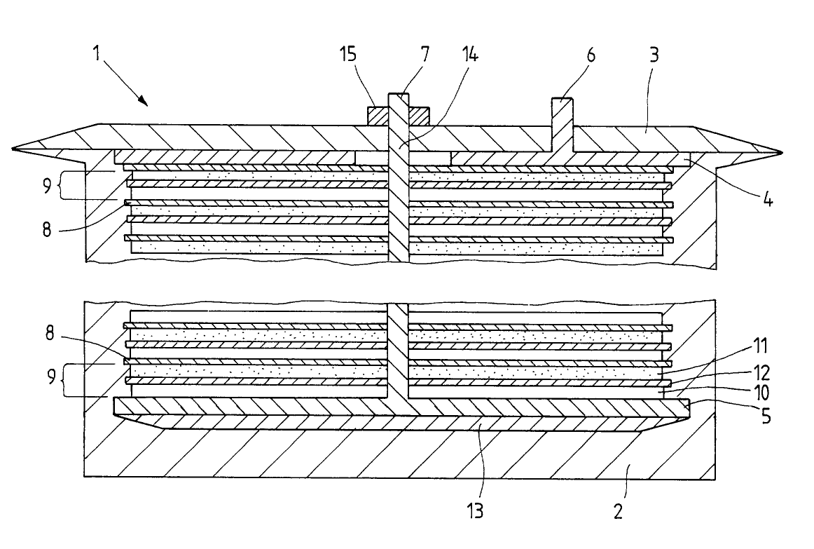

The accumulator 1 shown in the FIG. 1 is cylindrical in construction, with a circular base area.

In constructing the accumulator, first a housing 2 and a cover 3 are prepared. Sub-cells are then created by arranging positive and negative electrodes 10, 11 with separators 12 between them, with the electrodes being layered on top of one another with the intermittent formation of partitions 8. The individual sub-cells are equipped with electrolytes, and the contact plates 4 and 5 that delimit the stack are positioned. The tie rod 14, which is fastened to the pressure plate 13, is led through central openings in the electrodes 10, 11 and the separator 12, and through the conductive intermittent partitions 8 and the cover 3. By fastening the tie rod via the nut 15, the stack constructed from individual sub-cells 9 is charged with a determined pressure and is fastened to the cover 3 of the housing 2. Finally, the assembly comprised of the stacked sub-cells 9 and the cover is inserted into the housing 2, wherein the housing 2 is locked with the cover 3. Now the cover 3 and the housing 2 are fastened to one another in a pressure-proof connection via suitable fastenings, such as screws, and the electrolyte stored in the sub-cells 9 is activated.

In the accumulator 1 illustrated in the diagram, in accordance with the invention, the tie rod 14 is the only fastener holding the stack, which is formed by individual sub-cells 9 and is charged with pressure, in place. Additional fasteners are not used in accordance with the invention.

The exemplary embodiment illustrated in the diagram serves exclusively as an explanation and should not be understood as a limitation.

### REFERENCE LIST

1 Accumulator

2 Housing

3 Housing Cover

4 Contact Plate

5 Contact Plate

6 Negative Terminal

7 Positive Terminal

8 Conductive Partition

9 Sub-cell

10 Positive Electrode

11 Negative Electrode

12 Separator

13 Pressure Plate

14 Tie Rod

15 Nut

1. An accumulator in a bipolar stack configuration having a number of cells comprised of sub-cells (9) arranged in layers within a housing (2), separated by partitions (8), wherein each sub-cell (9) is equipped with a positive (10) and a negative (11) electrode and with a separator (12) positioned between the electrodes (10, 11), as well as electrolytes that are in contact with the electrodes,
characterized in
that the stack comprised of several sub-cells (9) layered on top of one another is held together via a force that holds the individual elements (8, 10, 11, 12) of the stack in contact with one another via a mechanical tie rod (14), and no other means of connection.

2. Accumulator according to claim 1, characterized in that the stack is fastened to the housing cover (3) via the tie rod (14).

3. Accumulator according to claim 2, characterized in that the housing cover (3) is fastened to the housing (2) in a pressure-proof connection via the tie rod (14) and the stack formed by individual sub-cells (9).

4. Accumulator according to one of the preceding claims, characterized in that contact plates (4, 5) are positioned adjacent to the first and last sub-cells (9) of the stack; these contact plates touch the sub-cells (9) and are connected to the terminals (6, 7) for contact with the accumulator.

5. Accumulator according to one of the preceding claims, characterized in that pressure plates (3, 13) are positioned at and delimit the ends of the stacks comprised of sub-cells (9).

6. Accumulator according to claim 5, characterized in that one of the pressure plates is formed by the housing cover (3).

7. Accumulator according to one of the preceding claims, characterized in that the tie rod (14) is led through the housing (2) or the housing cover (3) and forms an electrical terminal (7) for the accumulator.

8. Accumulator according to one of the preceding claims, characterized in that the tie rod (14) is led through central openings in the elements that form the stack of sub-cells (9) positioned on top of one another.

9. Accumulator according to one of the preceding claims, characterized in that the housing is cylindrical, preferably having a circular base area.

10. Accumulator according to one of the preceding claims, characterized in that the accumulator is a bipolar nickel/metal hydride accumulator.
